(19) United States
(12) Patent Application Publication
(10) Pub. No.: US 2007/0098202 A1
(43) Pub. Date: May 3, 2007

(54) VARIABLE OUTPUT EARPHONE SYSTEM

(76) Inventors: Steven Viranyi, Palatine, IL (US); Edgar Villchur, Woodstock, NY (US); Donald L. Wilson, Barrington, IL (US); Mead C. Killion, Elk Grove Village, IL (US); Jonathan K. Stewart, Bloomingdale, IL (US)

Correspondence Address: MCANDREWS HELD & MALLOY, LTD, 500 WEST MADISON STREET, SUITE 3400, CHICAGO, IL, 60661, US

(21) Appl. No.: 11/553,460

(22) Filed: Oct. 26, 2006

Related U.S. Application Data
(60) Provisional application No. 60/730,762, filed on Oct. 27, 2005.

(51) Int. Cl. H04R 25/00

(52) U.S. Cl. 381/380; 381/370

(57) ABSTRACT

Embodiments of the present invention relate to an earphone that allows for individual adjustment of different audio levels produced out of a first and second speaker to compensate for hearing impairment in one or both ears. The earphone may include a jack plug that is configured for insertion into an audio source that has a first volume control for setting the audio volume level produced by the first speaker. The earphone may also include a second volume control having an inlet and an outlet the inlet being operably connected to the jack plug. The second volume control may be configured to adjust the audio volume level produced by the second speaker. The maximum audio volume level of the second volume control may be approximately the same as the audio volume level set by the first volume control. The minimum audio volume of the second volume control may be inaudible.

### CROSS-REFERENCE TO RELATED APPLICATIONS/INCORPORATION BY REFERENCE

This application makes reference to and claims priority to U.S. Provisional Application Ser. No. 60/730,762, filed on Oct. 27, 2005, entitled “Variable Output Earphone System,” which is incorporated herein by reference in its entirety.

This application also makes reference to:
U.S. Pat. No. 4,170,720, issued on Oct. 9, 1979;
U.S. Pat. No. 5,128,566, issued on Jul. 7, 1992;
U.S. Pat. No. 5,131,046, issued on Jul. 14, 1992; and
U.S. Pat. No. 5,144,675, issued on Sep. 1, 1992.

Each of the above stated issued patents is hereby incorporated herein by reference in its entirety.

### BACKGROUND OF THE INVENTION

Earphones used in connection with the listening or play-back features of audio devices are widely used. For instance, the compact size of portable audio devices, such as variations of the Walkman™, compact disc devices, MP3 players, and iPods™, among others, along with the associated quality in stereo or digital sound produced by such devices, make these devices appealing to a large consumer base.

However, one segment of the population that is often unable to enjoy the full benefits of the sound quality obtainable through the use of earphones with such audio devices are individuals who have different hearing levels in each ear. For example a typical audio device has only one volume control. This limitation in volume control provides an individual who has hearing loss in one ear with few options. In such situations, the listener is unable to adjust or set the volume levels for each ear independently of the volume level set for the other ear so that the listener may both comfortably listen to the audio source and enjoy the effects of stereo or digital sound. For example, if the listener has the volume too low, the listener may be unable to hear the audio through one ear. Furthermore, periods of increased sound volume intended to compensate for the hearing loss In one ear may result in uncomfortable listening and/or hearing loss in the other ear.

In some prior art earphone devices, the volume level for one speaker channel may be manufactured to have a factory pre-set volume level that is higher or lower than the volume level of the other speaker channel. For example the earphone's right speaker channel may be pre-set to have a volume level that is 10 dB different than the earphone's left speaker channel. However, such devices do not allow the listener to control or adjust the difference in volume levels between each earphone speaker so as to suit the listener's particular hearing impairment.

Hearing loss may also affect an individual's ability to hear certain frequencies. For instance, many individuals with hearing loss may have normal or near normal hearing for low frequencies, but have difficulty hearing high frequencies. Further, some types of audio playback, music, or radio transmissions are essentially considered constant-level. In such situations, a hearing impaired listener may be able to obtain desirable audio levels without a significant negative impact on listening quality by adjusting the speaker balance, and perhaps with the addition of a treble boost. However, such adjustments are not desirable for all types of audio. For example, classical music may have a dynamic range of 30-50 dB. In such situations, more sophisticated electronics may be required to accommodate what is known as recruitment, which is the common experience that low-level sounds may be much more different in loudness between ears than high-intensity sounds for someone with a hearing loss in one ear.

Thus, a need exists for earphones that allow the listener to separately adjust the audio volume levels of each earphone speaker channel so as to accommodate for a hearing impairment in one ear or different hearing levels in both ears, and allow the listener to enjoy the effect of stereo or digital sound.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A variable output earphone system, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an earphone having an in-line volume control positioned along the wiring of the earphone, in accordance with an embodiment of the present invention.

FIG. 2 illustrates an electronic circuit that provides a volume control in accordance with an embodiment of the present invention.

FIG. 3 illustrates an electronic circuit that provides a volume control and a high frequency boost, in accordance with an embodiment of the present invention.

FIG. 4 illustrates an electronic circuit that provides a volume control, a high frequency boost, and a battery powered amplifier, in accordance with an embodiment of the present invention.

### DETAILED DESCRIPTION OF THE INVENTION

Embodiments of the present invention relate to an earphone that allows for individual adjustment of different audio levels produced out of a first and second speaker to compensate for hearing impairment in one or both ears. The earphone may include a jack plug that is configured for insertion into an audio source that has a first volume control, which may be used to set the audio volume level produced by the first speaker. The earphone may also include a second volume control having an inlet and an outlet, the inlet being operably connected to the jack plug. The second volume control may be configured to adjust the audio volume level produced by the second speaker. The maximum audio volume level of the second volume control may be approximately the same as the audio volume level set by the first volume control. The minimum audio volume of the second volume control may be inaudible.

In one embodiment of the present invention, a first volume control located on the audio source, such as a portable radio, compact disc player, tape player: ipod™, stereo, MP3 player, television, or computer, among others, is used to control the audio volume level of a first speaker that is heard by a hearing impaired ear. A second volume control may adjust the audio volume level setting of the first volume control so that volume level produced by the second speaker may be lower than that of the first speaker. The second volume control may be positioned on the earphone, earphone wiring, or connected between the audio source and the earphone. The second volume control may have a range that has a maximum level that is approximately equal to the audio volume level setting of the first volume control, and may be reduced to an at least nearly inaudible level.

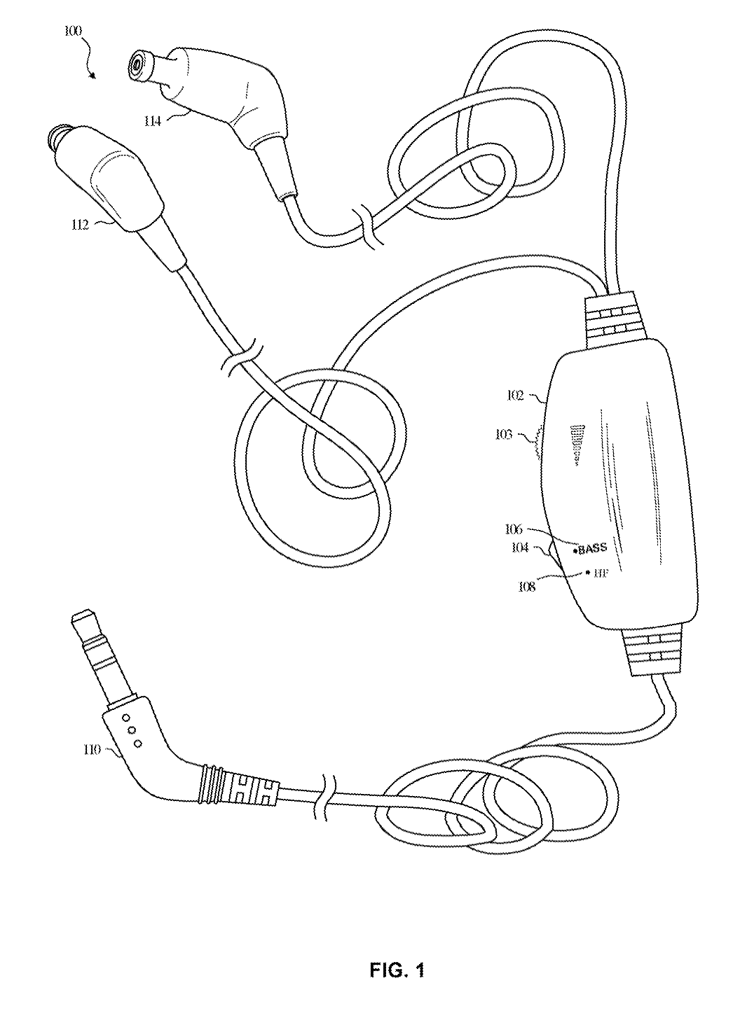

FIG. 1 illustrates an earphone having an in-line volume control positioned along the wiring of the earphone, in accordance with an embodiment of the present invention. Referring to FIG. 1, the earphone 100 may comprise a jack plug 110, a first speaker 112, a second speaker 114, and a first volume control 102 The jack plug 110 may be sized and configured to be inserted into an audio source that has a second volume control. The jack plug 110 may be operably connected to a first speaker 112 so that the first speaker 112 produces sound at a volume level in accordance with the volume setting of the second volume control.

The first volume control 102 may be an in-line volume control that is operably connected to the jack plug 110 and the second speaker 114. The wired connection between the jack plug 110 and the first volume control 102 may allow the first volume control 102 to receive approximately the same level of current and/or voltage that is delivered to the first speaker 112. Circuitry within the first volume control 102 may then adjust the delivered current and/or voltage so that the volume level produced by the second speaker 114 may be set by the listener to be lower than that produced by the first speaker 112. The first volume control 102 may comprise a dial 103, key pad (not pictured), or buttons (not pictured), among others, that allows the listener to adjust the audio volume level produced by the second speaker 114, for example. The first volume control 102 may also comprise a slide control, or a switch 104, for adjusting low and high frequency levels (designated by position HF 108) and/or selecting frequency responses, such as bass boost for example (designated by position BASS 106).

While FIG. 1 illustrates an earphone 100 having a jack plug 110 for insertion into an audio source, in another embodiment of the present invention, the earphone 100 may be wireless. In such an embodiment, a radio frequency transmitter may send or receive audio signals to or from the earphone 100. The earphone may then comprise circuitry that may allow the volume of each earphone speaker to be individually adjusted so as to accommodate the hearing abilities of each ear.

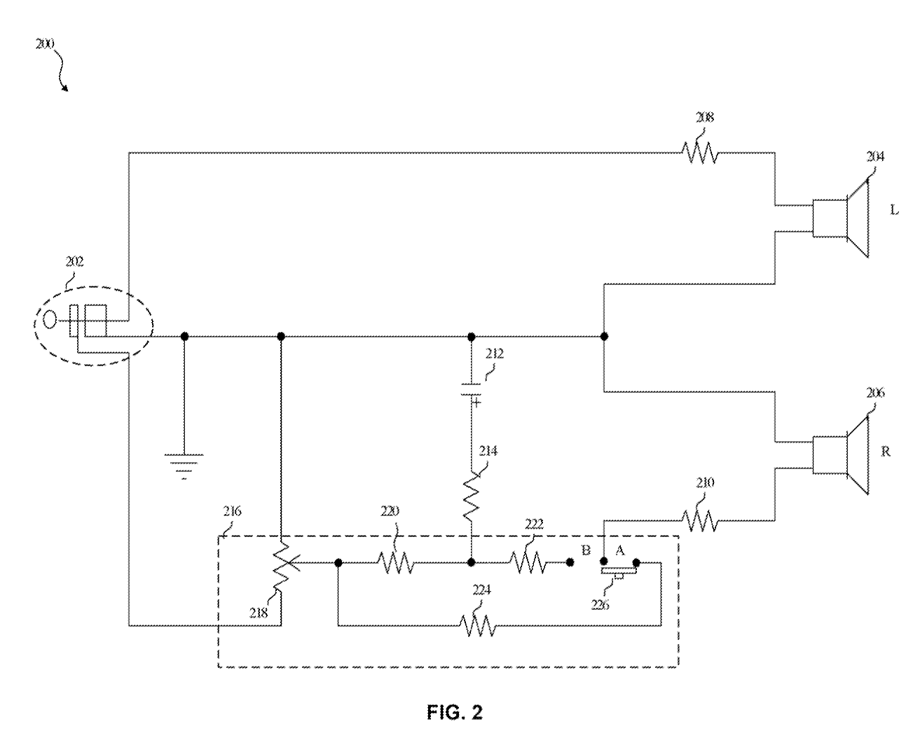

FIG. 2 Illustrates an electronic circuit that provides a volume control, in accordance with an embodiment of the present invention. Referring to FIG. 2, the earphone 200 may comprise a jack plug 202, a left earphone speaker (LES) 204, a right earphone speaker (RES) 206, and volume control circuitry (VCC) 216. The earphone 200 may further comprise a capacitor 212, and resistors 214, 210, and 208. The VCC may comprise a variable resistor 218, resistors 220, 222, 224, and a switch 226. The switch 226 may be adapted to select between positions A and B. In instances when the switch 226 is in position A, the RES 206 may be coupled to the variable resistor 218 via a first signal path comprising resistor 224. In instances when the switch 226 is in position B, the RES 206 may be coupled to the variable resistor 218 via a second signal path comprising resistors 220 and 222.

As shown, the jack plug 202 may be operably connected to wiring for the earphone speakers. For illustration purposes, the earphone wiring associated with the designation as being “left” (or L) may pass a current and/or voltage onto the first speaker channel that directs sound into the hearing impaired ear, while “right” (or R) designates the wiring that transports the current and/or voltage to the second volume control and then onto the second speaker channel. The left speaker channel wire is shown to pass the current and/or voltage from the audio source to the resistor 208 and then onto the first speaker. In such an arrangement, the volume level produced by the first speaker 204 may correspond to the volume level set by the volume control on the audio source coupled to the earphone 200 via the jack 202.

The right speaker channel wire may deliver the current and/or voltage from the audio source to the VCC 216. The VCC 216 may be configured to allow the listener to adjust the audio volume produced by the second speaker 206. In one embodiment of the invention, the VCC 216 may be configured so that the maximum volume produced by the second speaker is at least approximately equal to the audio volume level set by the volume control of the audio source that is coupled via the jack 202. However, the minimum volume level of the VCC 216 may permit the audio volume produced by the second speaker 206 to be reduced to an at least nearly inaudible level.

In an exemplary embodiment of the inventions a listener may place the first speaker 204 into a hearing impaired ear. The listener may then adjust the volume control on the audio source coupled to the earphone 200 via the jack 202 so that the volume level allows the individual to comfortably listen to the audio source through the hearing impaired ear. Then, with the second speaker 206 placed in the individual's other ear, the VCC 216 may be used to reduce the audio volume produced by the second speaker 206 to a level lower than that produced by the first speaker 204. By being able to adjust the volume levels of the first speaker 204 and the second speaker 206 individually, the listener may be able to customize the audio levels to suit his/her hearing needs or impairment(s). Such adjustments to the RES 206 may be performed independently of adjustments in the volume to the LES 204

In another embodiment of the invention, the listener may further independently adjust the RES 206 by using the switch 226 and selecting between the first signal path or the second signal processing path within the VCC 216. For example, the listener may obtain a relatively flat perceived frequency response for the RES 206 if the switch 226 is in position A, or a mild bass boost for the LES 206, if the switch 226 is in position B. Values for the resistors 220, 222, and 224 may be selected accordingly.

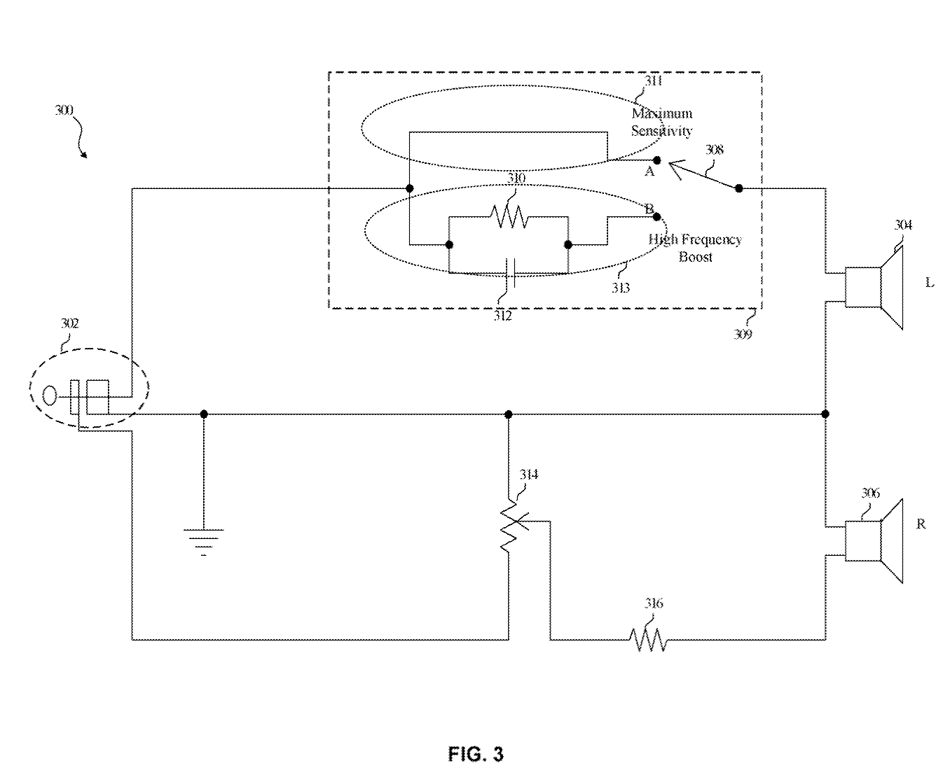

FIG. 3 illustrates an electronic circuit that provides a volume control and a high frequency boost in accordance with an embodiment of the present invention. Referring to FIG. 3, the earphone 300 may comprise a jack plug 302, a left earphone speaker (LES) 304 a right earphone speaker (RES) 306, and volume control circuitry (VCC) 314 The earphone 300 may further comprise a resistor 316 and a frequency boost circuit (FBC) 309.

The FBC 309 may comprise a switch 308, a capacitor 312, and a resistor 310 The switch 308 may be adapted to select between positions A and B. In instances when the switch 308 is in position A, the LES 304 may be directly coupled to the jack plug 302 via a first signal path 311, in instances when the switch 308 is in position B, the LES 304 may be coupled to the jack plug 302 via a second signal path 313 comprising the resistor 310 and the capacitor 312. In this regard, a high frequency boost may be activated within the earphone 300 by switching the switch 308 to position B. When activated via the switch 308, the high frequency boost may allow for an increase in the sensitivity of high frequency sounds in the LES 304, while also reducing the sensitivity of the LES 304 to low frequency sounds. For example, in one embodiment of the invention, activation of the high frequency boost may reduce the sensitivity of the LES 304 to low frequencies by approximately 15 dB. In this regard, the boost in high frequency and reduction in low frequency within the earphone system 300 may allow listeners who have a hearing impairment to hear a more natural sound.

Even though the VCC 314 is illustrated as comprising only a single variable resistor, the present invention may not be so limited. In another embodiment of the invention, the VCC 314 may be the same as the VCC 216 of FIG. 2.

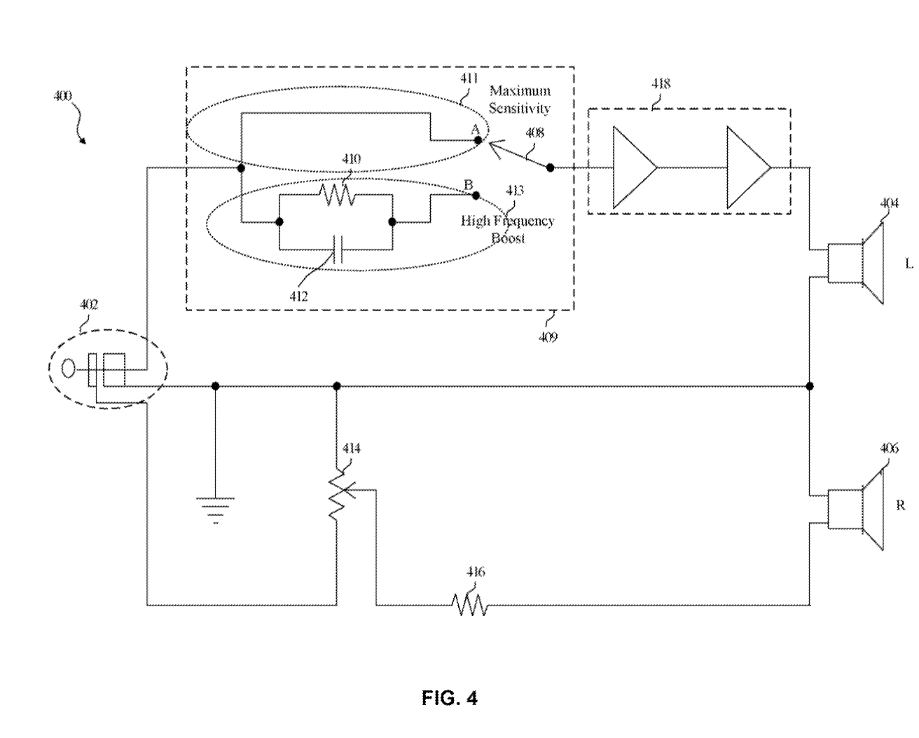

FIG. 4 illustrates an electronic circuit that provides a volume control, a high frequency boost, and a battery powered amplifier, in accordance with an embodiment of the present invention. Referring to FIG. 4, the earphone 400 may comprise a jack plug 402, a left earphone speaker (LES) 404, a right earphone speaker (RES) 406, and volume control circuitry (VCC) 414. The earphone 400 may further comprise a resistor 416, a frequency boost circuit (FBC) 409, and an amplifier 418.

The FBC 409 may comprise a switch 408, a capacitor 412, and a resistor 410. The switch 408 may be adapted to select between positions A and B. In instances when the switch 408 is in position A, the LES 404 may be directly coupled to the jack plug 402 via a first signal path 411. In instances when the switch 408 is in position B, the LES 404 may be coupled to the jack plug 402 via a second signal path 413 comprising the resistor 410 and the capacitor 412. In this regard, a high frequency boost may be activated within the earphone 400 by switching the switch 408 to position B. When activated via the switch 408, the high frequency boost may allow for an increase in the sensitivity of high frequency sounds in the LES 404, while also reducing the sensitivity of the LES 404 to low frequency sounds. For example, in one embodiment of the invention, activation of the high frequency boost may reduce the sensitivity of the LES 404 to low frequencies by approximately 15 dB. In this regard, the boost in high frequency and reduction in low frequency within the earphone system 400 may allow listeners who have a hearing impairment to hear a more natural sound.

In another embodiment of the invention, the earphone system 400 may utilize the amplifier 418 for increasing the dynamic range of music within the earphone system 400, thereby allowing for an increase in gain for quiet sounds. The amplifier 418 may comprise, for example, a battery-operated wide-dynamic range compression amplifier, such as a K-AMP. Furthermore, for those with hearing loss in both ears, battery operated amplifiers may be added to both the right and left channel. Even though a single amplifier is added in-line only to the LES 404, the present invention may not be so limited and another amplifier may be added in-line to the RES 406. Examples of such battery powered amplifiers are illustrated in U.S. Pat. Nos. 4,170,720, 5,128,566, 5,131,046, and 5,144,675, which are incorporated herein by reference in their entirety.

In yet another embodiment of the invention, by using a high-sensitivity earphone such as the Etymotic Research ER6i earphone, the full volume output with most portable players, when using the earphone system 300 in FIG. 3 or 400 in FIG. 4, will be adequate for a user/listener with at least a 70 dB hearing loss. When the hearing loss occurs mostly in the high-frequency region, the introduction of frequency selective circuits, such as the circuits represented by 313 in FIG. 3 or 413 in FIG. 4, will provide adequate output for a 70 dB high-frequency loss and less output where the hearing is closer to normal.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor Is available as an ASIC core or logic block, then the commercially available processor may be implemented as part of an ASIC device with various functions implemented as firmware.

The present invention may also be embedded in a computer program product, which comprises all the features enabling the implementation of the methods described herein and which when loaded in a computer system is able to carry out these methods. Computer program in the present context may mean for example any expression, in any language, code or notation, of a set of instructions intended to cause a system having an information processing capability to perform a particular function either directly or after either or both of the following; a) conversion to another language, code or notation; b) reproduction in a different material form. However other meanings of computer program within the understanding of those skilled in the art are also contemplated by the present invention.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments failing within the scope of the appended claims.

What is claimed is:

1. An earphone apparatus, comprising;
a first earphone speaker and a second earphone speaker;
a jack plug communicatively coupled to said first earphone speaker and said second earphone speaker, said jack plug configured for insertion into an audio source and for receiving at least one control signal for setting a first audio volume level produced by said first earphone speaker; and
volume control circuitry communicatively coupled to said jack plug and said second earphone speaker, said volume control circuitry configured to set a second audio volume level produced by said second earphone speaker,
wherein said second audio volume level is set independently of said first audio volume level.

2. The earphone apparatus of claim 1, wherein a maximum level for said second audio volume level is approximately the same as said first audio volume level.

3. The earphone apparatus of claim 1, wherein a minimum level for said second audio volume level is being at least almost inaudible.

4. The earphone apparatus of claim 1, wherein said volume control circuitry comprises an inlet and an outlet, said inlet operably connected to said jack plug through an earphone wire, said outlet operably connected to said second earphone speaker.

5. The earphone apparatus of claim 1, wherein said volume control circuitry comprises at least one variable resistor coupled to a first signal path and a second signal path within said volume control circuitry, said first signal path and said second signal path coupled to a switch for selecting between said first signal path and said second signal path during said setting of said second audio volume level.

6. The earphone apparatus of claim 5, wherein said first signal path comprises at least a first resistor, and wherein said second signal path comprises at least a second resistor.

7. The earphone apparatus of claim 5, wherein said second earphone speaker generates a flat frequency response, if said first signal path is selected via said switch.

8. The earphone apparatus of claim 5, wherein said second earphone speaker generates a bass boost response, if said second signal path is selected via said switch.

9. The earphone apparatus of claim 5, comprising a capacitor coupled to a neutral terminal of said jack plug and said second signal path within said volume control circuitry.

10. The earphone apparatus of claim 9, wherein said capacitor is coupled to said second signal path within said volume control circuitry via a resistor.

11. An earphone apparatus, comprising;
a first earphone speaker and a second earphone speaker;
a jack plug communicatively coupled to said first earphone speaker and said second earphone speaker, said jack plug configured for insertion into an audio source and for receiving at least one control signal for setting a first audio volume level produced by said first earphone speaker;
a frequency boost circuit communicatively coupled to said jack plug and said first earphone speaker;
volume control circuitry communicatively coupled to said jack plug and said second earphone speaker, said volume control circuitry configured to set a second audio volume level produced by said second earphone speaker,
wherein said second audio volume level is set independently of said first audio volume level.

12. The earphone apparatus of claim 11, wherein said frequency boost circuit comprises a switch coupled to a first signal path and a second signal path within said frequency boost circuit.

13. The earphone apparatus of claim 12, wherein said second signal path comprises a resistor and a capacitor.

14. The earphone apparatus of claim 12, wherein said frequency boost circuit increases sensitivity of said first earphone speaker to high-frequency sounds, if said second signal path is selected.

15. The earphone apparatus of claim 12, wherein said frequency boost circuit reduces sensitivity of said first earphone speaker to low-frequency sounds, if said second signal path is selected.

16. The earphone apparatus of claim 15, wherein said sensitivity of said first earphone speaker to said low-frequency sounds is reduced by approximately 15 dB, if said second signal path is selected.

17. The earphone apparatus of claim 11, comprising an amplifier coupled to said second earphone speaker and said volume control circuitry.

18. The earphone apparatus of claim 17, wherein said amplifier is configured to increase a dynamic range of sound signal communicated to said second earphone speaker.

19. The earphone apparatus of claim 17, wherein said amplifier comprises a battery-operated amplifier.
